(19) United States
(12) Patent Application Publication
(10) Pub. No.: US 2018/0263368 A1
(43) Pub. Date: Sep. 20, 2018

(54) ROTATIONAL SHELF GARDEN SYSTEM AND DEVICE

(71) Applicant: Richard Galles, Kirkland, AZ (US)

(72) Inventor: Richard Galles, Kirkland, AZ (US)

(21) Appl. No.: 15/460,068

(22) Filed: Mar. 15, 2017

(51) Int. Cl. A47B 49/00; A01G 27/00; A01G 9/12; A01G 1/00; A47B 81/00

(52) U.S. Cl. CPC A47B 49/002; A01G 27/003; A47B 81/00; A01G 1/001; A47B 49/008; A01G 9/12

(57) ABSTRACT

An rotational shelf garden system and device, including methods of use, are provided. The garden system and device include multiple hanging shelves mounted on a rotatable frame. Rotating the frame positions a shelf at a desired height for the user, wherein the user of the device may perform gardening activities while sitting or standing. Multiple vertically stacked shelves on a rotating frame, each shelf supporting garden plants, greatly reduces the “footprint” of the garden system versus a conventional outdoor garden, increasing the capacity for generating higher yields while using less ground space. The system and device includes a watering system integrated with each shelf.

### CROSS REFERENCE TO RELATED APPLICATION

This application claims priority from U.S. Provisional patent application Ser. No. ______, filed Mar. 17, 2016 and entitled “Stand-Up Garden,” by inventor Richard Galles which is incorporated entirely herein by reference.

### BACKGROUND OF THE INVENTION

### Technical Field

This invention relates to gardening devices and systems. Specifically, embodiments of the invention related to a rotational shelf garden system and device.

### State of the Art

A great many benefits derive from gardening, a widely-practiced activity. As a hobby, gardening is generally a very relaxing and rewarding activity. The fruits and vegetables produced are fresher and are usually much more flavorful than produce purchased from a grocery store or market. As a more practical matter, gardening is a source for an individual, family, or group of people to produce their own nutritious and sustaining foodstuffs without dependence on outside food production and distribution systems.

Regardless, conventional gardening is not available to some or otherwise problematic for a variety of reasons. Gardening takes up a lot of room outdoors, which may not be available to one living in an urban setting, or with a small lot or yard. Conventional gardening also requires stooping and kneeling to pull weeds and tend to individual plants. Gardening opportunities, therefore, are absent or severely limited for persons with back, knee, or other musculoskeletal problems. Moreover, opportunities to garden on a large scale are completely unavailable for one confined to a wheelchair.

Accordingly, what is needed is a system and device for gardening which maximizes available space and allows the gardener to perform gardening activities without stooping or kneeling, such as while sitting or standing.

### SUMMARY OF THE INVENTION

Embodiments of the present invention include a garden system with garden plants supported upon shelves adjustable to a height selected by the user, such that garden activities may be performed on the plants while the user is standing or sitting. Gardening at a height selected by the user is in contrast to kneeling or stooping to perform gardening activities in a conventional garden with the garden plant at ground level. Moreover, the garden system includes a system of conduits which bring water to the garden plants growing on each shelf.

Disclosed is a garden system comprising a frame; a plurality of shelves rotatably coupled to the frame; and an irrigation conduit disposed proximate to and moveable with regard to at least one of the shelves wherein said conduit maintains a substantially fixed position relative to said shelf as said shelf rotates.

In some embodiments, the device further comprises a crank operatively coupled to the frame, wherein rotation of the frame in response to turning the crank changes a height of the shelf. Some embodiments further comprises a lock disposed proximate to the crank, wherein engaging the lock with the crank prevents rotation of the frame. Some embodiments further comprise a motor operatively coupled to the frame, wherein the frame rotates in response to activation of the motor. In some embodiments, a timer electrically coupled to the motor; wherein the timer activates the motor at a preset time, changing the height of the shelf in response to rotation of the frame.

In some embodiments, the device further comprises a shut-off valve operatively coupled to the irrigation conduit. In some embodiments, a flow-regulating valve coupled to the irrigation conduit. Some embodiments further comprise a servo mechanically coupled to the shut-off valve; and a timer electrically coupled to the servo, wherein the servo causes the shut-off valve to move between an open position and a closed position in response to receiving an electrical signal from the timer.

Disclosed is a gardening system comprising a rotatable frame; a hanging shelf rotatably coupled to the frame; an irrigation means coupled to the hanging shelf; a motor operatively coupled to the rotatable frame, wherein the frame rotates in response to activation of the motor; a timer electrically coupled to the motor; a microprocessor communicatively coupled to the timer; and a sidereal clock utility resident on the microprocessor; wherein the timer activates the motor in response to receiving a first signal from the sidereal clock utility, causing a change in sunlight incident on the shelf in response to rotation of the frame.

In some embodiments, the system further comprises a shut-off valve operatively coupled to the irrigation conduit; a servo mechanically coupled to the shut-off valve; and a timer electrically coupled to the servo, wherein the servo causes the shut-off valve to move between an open position and a closed position in response to receiving an second signal from the timer.

Disclosed is a method for gardening comprising steps selecting a height value for a hanging shelf coupled to a rotating frame; rotating the frame until the hanging shelf is at the selected height; locking the rotating frame in a fixed position; and performing a gardening activity on an item supported by the hanging shelf.

In some embodiments, the rotating step is performed by manually turning a crank operatively coupled to the rotating frame. In some embodiments, the rotating step is performed by activating a motor operatively coupled to the rotating frame.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of a garden system;

FIG. 2 is a front view of a garden system;

FIG. 3 is a side view of a rotational means for a garden system;

FIG. 4a is an enlarged side view of a lock assembly for a garden system;

FIG. 4b is an enlarged front view of a lock assembly for a garden system;

FIG. 5a is a side view of a frame for a garden system;

FIG. 5b is a partial front view of a frame for a garden system;

FIG. 6 is a side view of a shelf mounted to a frame of a garden system;

FIG. 7 is a side view of a garden system with a watering means;

FIG. 8 is a partial front view of a watering means for a garden system; and

FIG. 9 is a diagram of a method for gardening.

### DETAILED DESCRIPTION OF EMBODIMENTS OF THE INVENTION

Conventional cultivation of fruits, vegetables, flowers, and the like generally requires soil, water, and sunlight. The most straightforward way to obtain these three core gardening elements it to plant in the ground outdoors, in a location wherein sunlight and water is available. For any purpose other than producing a limited harvest, conventional gardening requires a relatively large amount of space, particularly if the purpose of the garden is to produce substantially all of the fruits and vegetables to be consumed by a family or larger group of people. The growing plants require regular care, including watering, weeding, thinning, pruning, and the like. Many of these activities are performed at the level of the plant—on the ground. Consequently, many persons are not able to have a garden which produces a substantial yield due to limited available of outdoor space/ground space. Moreover, a great many persons with physical disabilities and limitations are not able to tend to plants on the ground.

The foregoing application describes a device and system for gardening utilizing a fraction of the space otherwise required by a medium-sized or larger garden while allowing the gardener to tend the garden while standing, sitting, or at any chosen height. Disclosed is a garden system, including a plurality of hanging shelves mounted on a rotatable frame. The hanging frame may be rotated by a user of the garden system until a hanging shelf is located at a height above the ground and then locked into place, whereupon the user can perform gardening activities on plants supported by the height-adjusted and secured shelf while standing or sitting, as desired. In the absence of an external source of water, each shelf includes watering means that may be coupled to or unitary with the shelf itself.

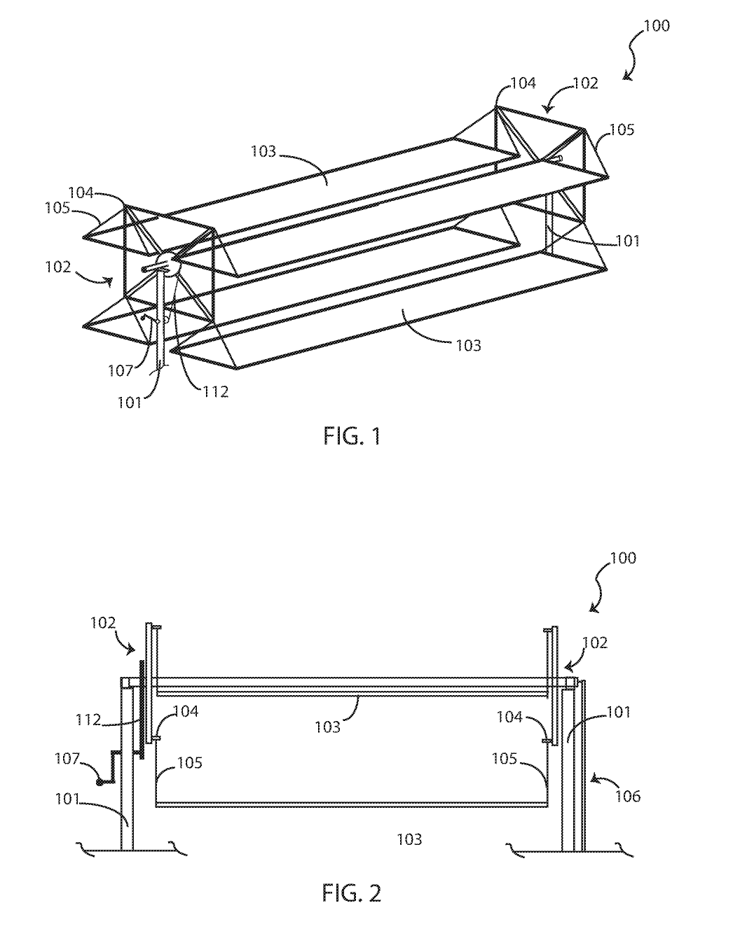

FIG. 1 is a perspective view of a garden system. FIG. 1 shows a garden system 100 comprising two support members 101, a frame 102, and a plurality of shelves 103. Each support member 101 is inserted into the ground or otherwise mounted in or on a substantially rigid and stable surface to support the weight of garden system 100. Support member(s) 101 are rotatably coupled to a frame 102. Each of the plurality of shelves 103 are, in turn, rotatably coupled to frame 102 at a shelf pivot 104 by a shelf hanger 105, wherein each shelf 103 self-rotates to remain substantially level with rotation of frame 102. Support members 101 are fixed apart at a distance slightly longer than each shelf 103 to allow each shelf 103 clearance to freely rotate around each corresponding shelf pivot 104. Each shelf 103 provides a supporting surface for the garden plants to be cultivated, whether in pots, soil beds, and like structures resting upon and supported by each shelf 103.

Because the plurality of shelves 103 coupled to frame 102 can be vertically stacked, the “footprint” of garden system 100 is a fraction of that required for a conventional garden. For example, the embodiment of garden system 100 shown in FIG. 1 comprises four shelves 103, whereupon gardening activities take place. It will be appreciated from FIG. 1 that the combined surface area of all four shelves 103 exceeds the ground surface area or “footprint” occupied by garden system 100. Moreover, wherein garden system 100 comprises greater than four shelves 103, the surface area available for gardening activities increases incrementally while the footprint remains unchanged.

A user of garden system 100 may select a shelf 103 upon which to undertake a gardening activity. After choosing which shelf 103 is supporting the garden plants (not shown in the drawing figures) which the user wants to access, the user rotates frame 102 to position the selected shelf 103 at a comfortable height for the user, whether the user's desired gardening position is standing, sitting, or kneeling.

FIG. 1 also shows a means to cause rotation of frame 102; namely a crank 107. Crank 107 is operatively coupled to frame 102, wherein rotation of frame 102 in response to turning crank 107 changes a height of shelf 103. Some embodiments comprise additional elements which drive, restrict, automate, and otherwise modify rotation of frame 102, and will be discussed in detail herein.

FIG. 2 is a front view of a standing garden. As shown by FIG. 2, garden system 100 additionally comprises a watering means 106. In the embodiment shown by FIG. 2, watering means 106 is coupled to frame 102 and acts to supply water to a shelf conduit 109 (not shown in FIG. 2; see FIG. 8). Shelf conduit 109 is proximate to and moveable with shelf 103, such as coupled to or integral with shelf 103, for example. Watering means 106 may comprise a pipe or similar conduit coupled to a point of rotation, such as the center of an axle member of frame 102, utilizing a rotating pipe connector or similar means for rotatably coupling pipe conduits known in the plumbing and irrigation arts. In this manner, watering means 106 provides water to shelf conduit 109 and remains stationary as frame 102 is rotated. Watering means 106 is fluidly coupled to an external water source, such as a watering hose, an irrigation pipe, or the like. Shelf conduit 109 maintains a substantially fixed position relative to shelf 103, even as shelf 103 moves relative to frame 102 when frame 102 is rotated. In this manner, garden system 100 provides an even supply of water to plants cultivated on each shelf 103, regardless of the position of shelf 103 with respect to frame 102 and support member 101, and regardless of whether additional shelves 103 are positioned above, below, or to the side of a single shelf 103. Shelf conduit 106 is discussed in detail herein below.

An example embodiment of crank 107 is shown by FIG. 2. In this and some other embodiments, crank 107 is a mechanical crank arm fitted with a suitable grip, such as a rotatable knob or handle, wherein a user can turn crank 107 causing frame 102 to rotate upon support member 101. Crank 107 is operatively coupled to frame 102 by a crank coupling means 112. Crank coupling means 112 is any suitable means to translate rotation of crank 107 to rotation of frame 102. Some non-limiting examples of crank coupling means 112, in some embodiments, include assemblies of a chain-and-sprocket, belt-and-pulley, or cable-and-pulley. In some embodiments, crank 107 is coupled directly to or unitary with frame 102 and crank coupling means 112 is not present. In some embodiments, crank 107 is mechanically coupled to frame 102 through an intermediate movement transfer means other than a chain or cable, such as a system comprising a gear, a friction plate, or the like.

FIG. 2 also shows shelf pivot 104 and shelf hanger 105. Each end of shelf 103, in some embodiments, hangs freely from shelf pivot 104 by shelf hanger 105, such that shelf 103 rotates with relation to frame 102 to remain essentially level, despite rotation of frame 102. Shelf hanger 103 may comprise a flexible member, such as a length of chain or cable. Alternatively, shelf hanger 104 is a rigid member.

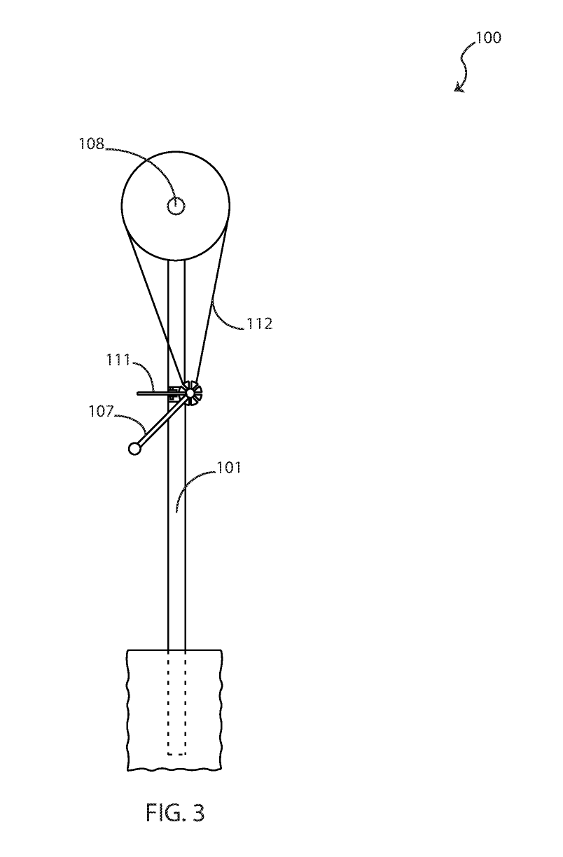

FIG. 3 is a side view of a rotational means for garden system 100. FIG. 3 shows details wherein frame 102 is rotatably coupled to support member 101, and wherein frame 102 is rotated in response to turning crank 107. Rotation of frame 102 of garden system 100 permits a user to adjust the height of any of the plurality of shelves 103 to a desired level. The user may, therefore, perform gardening activities directly with the user's hands from a standing or sitting position, and not be required to stoop or kneel to access plants. Rotation of frame 102 additionally allows a shelf 103 to be moved beneath a shading member into full or partial shade, or out from under a shading member into full sunlight, wherein the user may easily alter the amount of sunlight reaching a garden plant supported by shelf 103 to match the growing requirements of the plant and the ambient light and temperature conditions wherein garden system 100 is employed.

For safety, support member 101 is fixed in a substantially rigid and stable position. In the embodiment shown in FIG. 3, and in some other embodiments, support member 101 is rigidly fixed below grade, such as set in concrete, for example. This is by way of example and not meant to be limiting. Frame 102 is rotatably coupled to support member 101 by a rotatable coupling 110. Rotatable coupling 110 is a suitable rotating support means known in the art. In the example shown by FIG. 3, frame 102 comprises a generally cylindrical axle that rests on rotatable coupling 110 comprising a roller assembly coupled to support member 101, however, rotatable coupling 110 may comprise any suitable rotatable coupling means known it the art, including, but not limited to, a roller bearing, a sleeve bearing, a bushing, a cradle, and the like.

FIG. 3 also shows crank 107 coupled to support member 101 and a lock 111. Crank 107 is also shown operatively coupled to frame 102 by crank coupling means 112. Crank coupling means 112 comprising, a chain, a flat belt, a V-belt, or the like may be used. In the example embodiment shown by FIG. 3, crank coupling means passes from crank 107 upward to encircle a wheel member 118 coupled to frame 102 at the center of rotation 108 of frame 102. Wheel member 118 comprises a feature to engage crank coupling means 112. For example, wherein crank coupling means 112 comprises a chain, wheel member 118 comprises a sprocket. Wherein the operative coupling means is a belt, the wheel-shaped member is a pulley engaging the belt at a friction surface of the pulley. Alternatively, in some embodiments, crank 107 is directly coupled to or unitary with frame 102, such as embodiments wherein crank 107 extends directly from frame 102 at its center of rotation 108, located proximate to rotatable coupling 110. Lock 111 is disposed proximate to crank 107, wherein engaging lock 111 with crank 107 prevents rotation of crank 107, thus preventing rotation of frame 102.

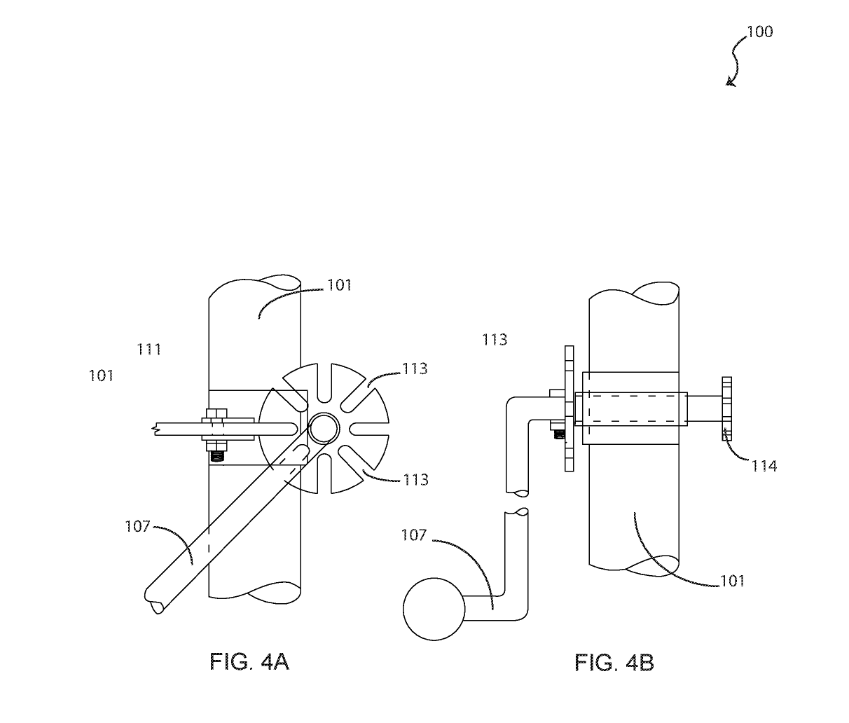

FIG. 4a is an enlarged side view of a lock for a garden system. Lock 111 reversibly engages with crank 107 such that under a condition wherein lock 11 is engaged, crank 107 and frame 102 are fixed in position. Many designs of lock 111 are possible. In the non-limiting example embodiment shown in FIG. 4a, lock 111 is a substantially flat member coupled to support member 101, and which rotates to reversibly engage with one of a plurality of engagement features 113 on crank 107. Alternative structures of lock 111 may include a friction brake, a pin-in-hole, a ratchet stop, and the like. Regardless, lock 111 is disengaged from crank 107 to allow a user to turn crank 107, changing the height of shelf 103, and then re-engaging lock 111 with crank 107 to fix the position of shelf 103. In some embodiment of garden system 100 lacking crank 107, lock 111 reversibly engages directly with frame 102 to prevent rotation of frame 102.

FIG. 4b is an enlarged front view of a lock for a garden system. In the embodiment of garden system 100 shown in FIG. 4b, crank coupling means 112 comprises a sprocket 114 to engage with a chain. Sprocket 114 may alternatively be a pulley, a gear, or a similar engagement means. It can be appreciated that by utilizing sprocket 114 comprising a small diameter relative to the diameter of wheel member 118, a mechanical advantage is created wherein a user may cause rotation of frame 112 by applying minimal rotational force to crank 107. This mechanical advantage is important to allow smooth rotation of frame 102 wherein heavy loads, including soil and large pots, are placed on the plurality of shelves 103.

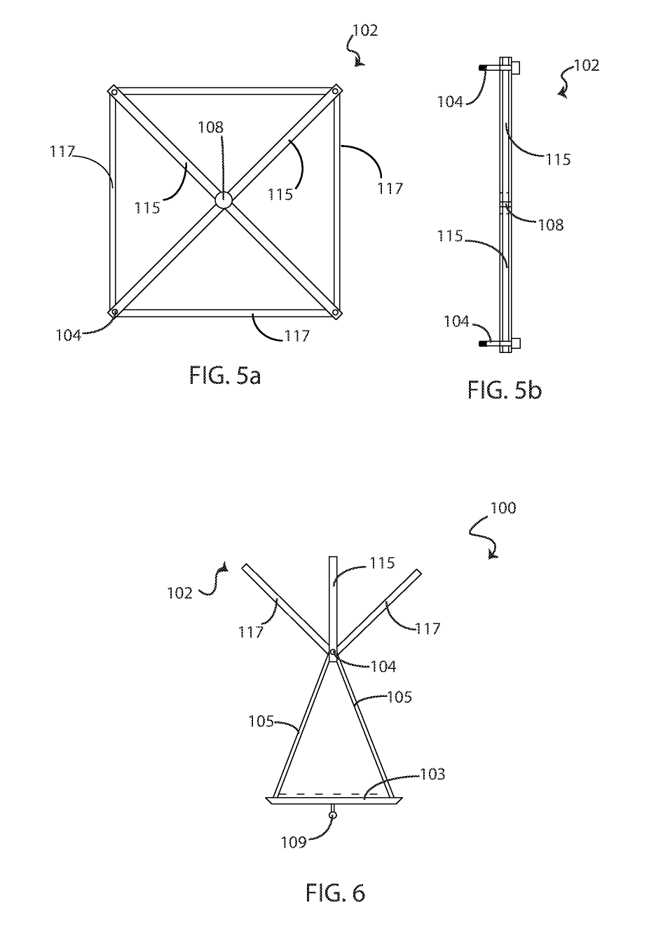

FIG. 5a is a side view of a frame for a standing garden. FIG. 5a shows frame 102 comprising a plurality of brace members 115 coupled to and extending radially from an axle 116. Each frame member 117 is coupled to two brace members at each shelf pivot 104. Within the scope of the aforementioned requirements, many designs of frame 102 are possible and contemplated for embodiments of the invention. In the embodiment shown in FIG. 4a, FIG. 4b, FIG. 1, and other drawing figures, frame 102 generally circumscribes a rectangle. The approximately square shape of frame 102 shown in the drawing figures is not meant to be limiting, and embodiments of garden system 100 may comprise many shapes of frame 102, determined by the number of shelves 103 coupled to frame 102 and the number and configuration of brace members 115 and frame members 117 necessary to provide adequate structural strength to support the weight of each shelf 103 when fully loaded with garden plants.

FIG. 5b is a partial front view of a frame of garden system 100 showing two brace members 115, two shelf pivots 104 disposed around center of rotation 108. In some embodiments, shelf 103 is suspended from shelf pivot 104 by shelf hanger 105, as discussed herein above. Shelf pivot 104 is a means wherein shelf is rotatably coupled to frame 102, and wherein shelf 103 may freely rotate to remain generally level when frame 102 rotates.

FIG. 6 is a side view of a shelf mounted to a frame of a garden system. FIG. 6 shows additional details of the rotatable coupling between shelf 103 and frame 102. Two frame members 117 and one brace member 114 intersect at shelf pivot 104, wherein forces arising from the weight of shelf 103 acting on shelf pivot 104 are counteracted, creating a point of rigid, rotatable support for shelf 103.

Each shelf 103 is rotatably coupled to at least one pivot point 114 disposed at each long end of shelf 103, in some embodiments. Shelf 103 comprises a generally elongate, rectangular shape. In some embodiments, shelf 103 comprises an open lattice construction upon which potted garden plants may be places and through which water may pass freely such that water, dirt and the like are not retained on shelf 103. In some embodiments, shelf 103 is of generally solid construction, as a solid sheet of material. Garden plants may be planted in individual pots or similar containers and placed on shelf 103. In some embodiments, however, shelf 103 may comprise a bounded structure filled with and retaining a volume of soil, in which garden plants are planted. Some embodiments of garden system 100 comprise four shelves 102, including the embodiments shown in the several drawing figures. In some embodiments, however, garden system 100 comprises five or more shelves 103. In some embodiments, garden system 100 may comprise only two or three shelves 103. Although shelf hanger 105 couples shelf 103 to shelf pivot 104 in the embodiments shown in the drawing figures, in some other embodiments, shelf 103 is directly coupled to shelf pivot 104 without an intervening shelf hanger 105.

FIG. 6 additionally shows shelf conduit 109 coupled to an undersurface of shelf 103. This is not, however, meant to be limiting; shelf conduit 109, in some embodiments, is coupled to a top surface, a side surface or molded into the substance of shelf 103 as a unitary body.

Rotation of frame 102 provides for a user of garden system 100 to regulate sunlight incident upon garden plants supported an each shelf 103. For example, in some embodiments, a shade element (described herein but not shown in the drawing figures) is present which casts full or partial shade on a first shelf 103 while a second shelf 103 remains in full sunlight or under different light conditions than first shelf 103. For example, in some embodiments, garden system 100 is set-up next to a house or other building structure, near a shade tree or other shade-providing vegetation, or proximate to a similar natural or human-created shade-creating element. In some embodiments (not shown) the shade element is coupled to support member 100. In some embodiments, the shade element is coupled to shelf 103. In some embodiments, the shade element is coupled to frame 102.

In some embodiments of garden system 100, a first motor is operatively coupled to the rotatable frame wherein activation of the first motor causes rotation of frame 102. In some embodiments, a first timer is electrically coupled to the first motor. In some embodiments, a microprocessor is communicatively coupled to the first timer. A user may choose to activate the motor in order to rotate frame 102. A user wishing to rotate frame 102, such as to change the light exposure of a garden plant supported by shelf 103, may set the first timer to a time or time interval, wherein upon reaching the time or the time interval, the motor rotates frame 102 to a pre-set position in response to a first signal from the first timer. Further, in some embodiments comprising a microprocessor, the user may program the microprocessor to repeatedly generate a first signal the first timer to activate the motor on a multi-event schedule selected by the user.

In some embodiments, garden system 100 comprises a sidereal clock resident on the microprocessor, wherein the sidereal clock provides a signal to the timer regulating sunlight incident on shelf 103 according to the changing incident angle of sunlight with the progression of seasons at the latitude wherein garden system 100 is used.

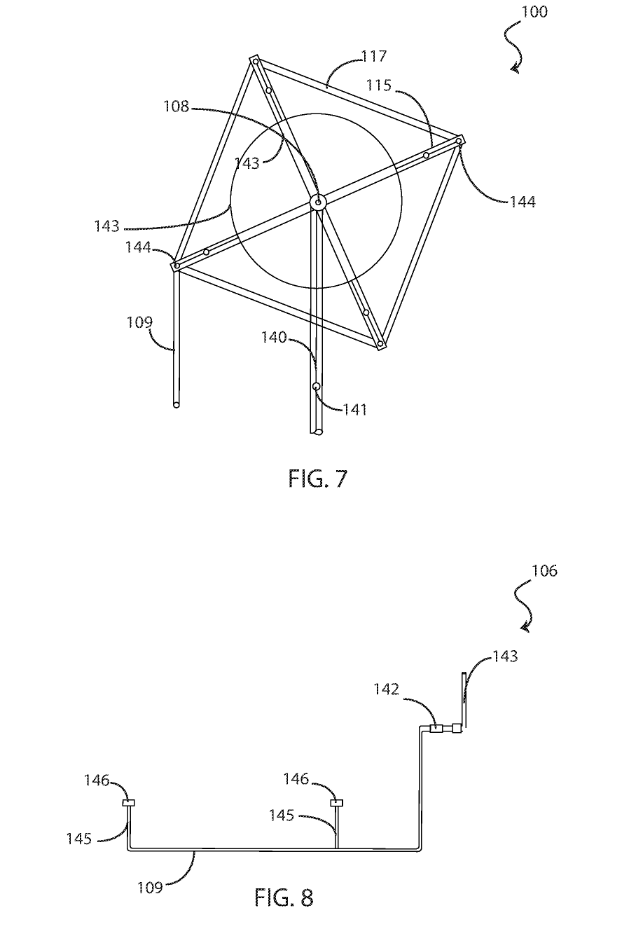

FIG. 7 is a side view of a garden system with a watering means. FIG. 8 is a partial front view of a watering means for a garden system. Elements of watering means 106 are shown by FIG. 7 and FIG. 8, which will be discussed together. FIG. 7 shows a supply tubing 140 coupled to a water source at a shut-off valve 141. The water may comprise an irrigation timer/controller or similar means to regulate the supply of water to garden system 100. Shut-off valve 141 is a commercially available hand-operated valve, in some embodiments. In some alternative embodiments, shut-off valve 141 comprises a servo motor electrically activated to move valve 141 between an open position and a closed position. In the embodiments shown by FIG. 7 and FIG. 8, and in some other embodiments, supply tubing 140 fluidly couples the water supply to a spoke joint 142 at the center of rotation 108 (not shown in FIG. 7, see FIG. 8) of frame 102. Spoke joint 142 is a rotatable fluid coupling joint, as previously discussed herein, wherein two coaxial segments of a pipe or conduit in fluid communication are mechanically coupled such that one segment may rotate coaxially with respect to the other segment. From spoke joint 142, water is provided to shelf conduit 109 by a tubing array 143. One of many possible such tubing arrays is shown by FIG. 8, wherein two segments of tubing between spoke joint 143 are coupled to an ellipsoid-shaped conduit mounted on frame 102. Connecting conduits from the ellipsoid conduit deliver water to shelf conduit 109 along brace member 115, and are fluidly coupled to shelf conduit 109 by a shelf joint 142. Shelf joint 142 is a rotatable fluid coupling joint similar to spoke joint 143, in some embodiments. Shelf joint 142 is located at shelf pivot 104.

FIG. 8 is a partial front view of a watering means for a garden system. FIG. 8 shows watering means 106 with other structural elements of garden system 100 omitted for clarity. As discussed herein, supply tubing 140 is fluidly coupled to tubing array 143 at spoke joint 142 disposed proximate to shelf pivot 104. Spoke joint 142 is, in turn, fluidly coupled to shelf conduit 109. Tubing array 143 comprises all conduit which fluidly couples spoke joint and spoke joint 142. As will be appreciated by one with skill in the art, many designs and configurations are possible for tubing array 143, although such configurations may be limited by the general shape of frame 102, the number of shelves 103 comprising garden system 100.

In some embodiments, shelf conduit 109 comprises a riser 145 capped with a flow port 146, as shown by FIG. 8. Flow port 146, in some embodiments, is an adjustable spray-valve that may be rotated upon riser 145 or otherwise adjusted to regulate the rate of flow and the pattern of spray of water emitted by shelf conduit 109 and watering the garden plants supported by shelf 103. A user of garden system 100 may individual adjust each flow port 146, according to the watering requirements of garden plants receiving water from each flow port 146. In some embodiments, flow port 146 is manually adjustable. In some embodiment, flow port 146 is operatively coupled to an electrically activated adjustment means (not shown in the figures).

FIG. 8 additionally shows shelf conduit 109. Shelf conduit 109 comprises all conduit from shelf joint 144 to riser 145, wherein shelf conduit 109 creates a fluid coupling between shelf joint 144 and riser 145. In some embodiments, shelf conduit 109 comprises a length of conduit formed from any commercially available irrigation tubing and is coupled to any exterior surface of shelf 103, such as along a length of shelf 103. In some embodiments, a portion of shelf conduit 109 within the substance forming shelf 103 and shelf 103 are formed as a unitary body, such as in some embodiments wherein shelf 103 is formed from a plastic polymer using an injection molding process, for example.

In some embodiments, delivery of water to shelf conduit 109 is regulated by a flow regulating valve operatively coupled to the irrigation conduit. The flow regulating valve is a manually activated valve, in some embodiments. In some embodiments, the flow regulating valve is activated by a servo motor in response to receiving a signal from a second timer. The flow regulating valve functions to set a rate of flow of water through watering means 106 independent of a water pressure of the outside water source delivered to supply tugging 140 in response to measuring the flow rate of water through supply tubing 140. In some embodiments comprising a servo operatively coupled to shut-off valve 141, the second timer is electrically coupled to the servo, wherein the servo causes the shut-off vale to move between an open position and a closed position in response to receiving a second signal from the second timer.

The components defining any garden system device may be formed of any of many different types of materials or combinations thereof that can readily be formed into shaped objects provided that the components selected are consistent with the intended operation of a garden system. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any garden system device may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, inj ection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

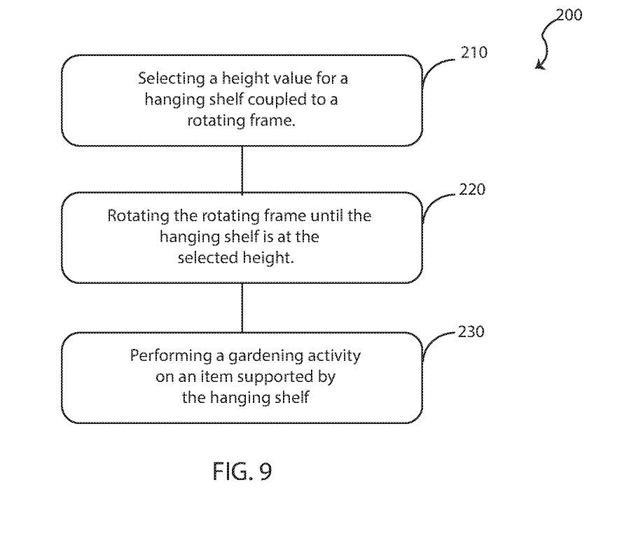

FIG. 9 is a diagram of a method for gardening. FIG. 9 shows a method for gardening 200 comprising a selecting step 210, a rotating step 220, a locking step 230 and performing step 240. Selecting step 210 comprises selecting a height value for a hanging shelf coupled to a rotating frame. Some persons performing method for gardening 200 will choose to garden on a hanging shelf supporting garden plants from a standing position, with the shelf at a comfortable height to directly access while standing. Other persons who may be more comfortable gardening from a seated position may choose a height for the shelf which is comfortable to reach when sitting in a chair or on a bench. Moreover, persons confined to a wheelchair are able to select a shelf height for access to garden plants from the wheelchair.

Once the person performing method 200 selects the shelf height at which to perform a gardening activity, that person then performs rotating step 220. Rotating step 220 comprises rotating the frame until the hanging shelf is at the selected height. In some embodiments, rotating step 220 is performed with the aid of a crank operationally coupled to the frame, wherein a user manually turns the crank, causing rotation of the frame until the desired hanging shelf is located at the selected height. The operational coupling may be accomplished by a chain-and-sprocket assembly, belt-and-pulley assembly, interlocking gears, contacting friction members, and the like. In some embodiments, rotating step 220 is performed without a crank, wherein the user grasps the frame directly and rotates it until the hanging shelf has reached the selected height. In some embodiments, rotating step 220 is performed by activating a motor operatively coupled to the rotating frame.

Following rotation of the frame to place the hanging shelf at the selected height, one then performs locking step 230, comprising locking the rotating frame in a fixed position. Locking step 230 is performed, in some embodiments, by rotating a locking member into a corresponding feature on the crank, such as a slot, recess, groove, the like shaped to receive the locking member. In some embodiments, locking member comprises a friction brake which engages with the crank. In some embodiments, locking member engages directly with the rotating frame.

Performing step 240 comprises performing a gardening activity on an item supported by the hanging shelf. Some non-limiting examples of gardening activities include planting, thinning, weeding, pruning, harvesting, and the like. The user performing method 200 is able to perform gardening activities on the garden plant at a height comfortable for the user, and wherein the shelf supporting the garden plant has been rotated and locked securely into position.

A rotational shelf garden system and device, including a method of use, are disclosed. The garden system and device overcome deficiencies of the existing art by allowing a user of the device to perform gardening activities while sitting or standing, and by providing a plurality of vertically stacked shelves on a rotating frame for placement of garden plants, wherein the “footprint” of the garden is greatly reduced.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. A garden system comprising:
a frame;
a plurality of shelves rotatably coupled to the frame; and
an irrigation conduit disposed proximate to and moveable with regard to at least one of the shelves wherein said conduit maintains a substantially fixed position relative to said shelf as said shelf rotates.

2. The device of claim 1, further comprising a crank operatively coupled to the frame, wherein rotation of the frame in response to turning the crank changes a height of the shelf.

3. The device of claim 2, further comprising a lock disposed proximate to the crank, wherein engaging the lock with the crank prevents rotation of the frame.

4. The device of claim 2, further comprising a lock disposed proximate to the frame, wherein engaging lock with the frame prevents rotation of the frame.

5. The device of claim 1, further comprising a motor operatively coupled to the frame, wherein the frame rotates in response to activation of the motor.

6. The device of claim 4, further comprising:
a timer electrically coupled to the motor; wherein the timer activates the motor at a preset time, changing the height of the shelf in response to rotation of the frame.

7. The device of claim 1, further comprising a shut-off valve operatively coupled to the irrigation conduit.

8. The device of claim 6, comprising a flow-regulating valve coupled to the irrigation conduit.

9. The device of claim 5, further comprising:
a servo mechanically coupled to the shut-off valve; and
a timer electrically coupled to the servo, wherein the servo causes the shut-off valve to move between an open position and a closed position in response to receiving an electrical signal from the timer.

10. A gardening system comprising:
a rotatable frame;
a hanging shelf rotatably coupled to the frame;
an irrigation means coupled to the hanging shelf;
a motor operatively coupled to the rotatable frame, wherein the frame rotates in response to activation of the motor;
a timer electrically coupled to the motor;
a microprocessor communicatively coupled to the timer; and
a sidereal clock utility resident on the microprocessor; wherein the timer activates the motor in response to receiving a first signal from the sidereal clock utility, causing a change in sunlight incident on the shelf in response to rotation of the frame.

11. The gardening system of claim 9, further comprising:
a shut-off valve operatively coupled to the irrigation conduit;
a servo mechanically coupled to the shut-off valve; and
a timer electrically coupled to the servo, wherein the servo causes the shut-off valve to move between an open position and a closed position in response to receiving an second signal from the timer.

12. A method for gardening comprising steps:
selecting a height value for a hanging shelf coupled to a rotating frame;
rotating the frame until the hanging shelf is at the selected height;
locking the rotating frame in a fixed position; and
performing a gardening activity on an item supported by the hanging shelf.

13. The method of claim 9, wherein the rotating step is performed by manually turning a crank operatively coupled to the rotating frame.

14. The method of claim 9, wherein the rotating step is performed by activating a motor operatively coupled to the rotating frame.
